(19) United States
(12) Patent Application Publication
(10) Pub. No.: US 2010/0245961 A1
(43) Pub. Date: Sep. 30, 2010

(54) OPTICAL DEVICE, OPTICAL SCANNER, AND IMAGE FORMING APPARATUS

(75) Inventors: Yasushi MIZOGUCHI, Suwa (JP); Makiko NAKAMURA, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/701,021

(22) Filed: Feb. 5, 2010

(30) Foreign Application Priority Data
Mar. 26, 2009 (JP) 2009-075919

(51) Int. Cl. G02B 26/10; G02B 26/08

(52) U.S. Cl. 359/212.1

(57) ABSTRACT

An optical device includes: a movable plate disposed in an area over which externally incident light is spread, the movable plate having a light reflecting surface that reflects the light; and an axis member that swingably supports the movable plate around a predetermined axis, wherein each portion in the light spread area but other than the movable plate is formed of a surface having a normal vector along which the light is reflected and directed outside a predetermined area.

The entire disclosure of Japanese Patent Application No: 2009-075919, filed Mar. 26, 2009 is expressly incorporated by reference herein.

### BACKGROUND

1. Technical Field

Some aspects according to the present invention relate to an optical device, an optical scanner, and an image forming apparatus produced, for example, by using a MEMS (Micro Electro Mechanical System) technology and having a movable plate making reciprocating motion around an axis member.

2. Related Art

An optical device of this type that has been known in the related art includes a magnetic field generator and a scan mirror. Both ends of the scan mirror are supported by a support member in such a way that the scan mirror can be angularly displaced around a drive axis. The scan mirror has a mirror portion formed on one side and a permanent magnet formed on the other side. The magnetic field generator is disposed on the other side of the scan mirror and apart therefrom by a predetermined distance. In the thus configured optical device, since the scan mirror, which has a light weight because only the thin-film permanent magnet is formed on the other side thereof, is driven alone, the scan mirror can be readily driven by a relatively small drive force even when the scan mirror is large in size (see JP-A-6-82711, for example).

In general, since the area over which the light incident on an optical device is spread is larger than a movable plate having a light reflecting surface (mirror), the light may also be incident on portions of the optical device outside the movable plate. In this case, the light incident on the portions other than the movable plate does not move even when the movable plate is driven (scanned), and the reflected light always stays in the same position. As a result, the light incident on the portions other than the movable plate could disadvantageously become stray light, for example, in an area to which the light reflected off the movable plate is directed and on other optical devices, mirrors, and screens (including screens irradiated with light via other optical devices, mirrors, and other components) including the area to which the light reflected off the movable plate is directed.

### SUMMARY

An advantage of some aspects of the invention is to provide an optical device, an optical scanner, and an image forming apparatus capable of reducing the amount of stray resulting from the light incident on portions other than a movable plate.

An optical device according to an aspect of the invention includes a movable plate disposed in an area over which externally incident light is spread, the movable plate having a light reflecting surface that reflects the light, and an axis member that swingably supports the movable plate around a predetermined axis, and each portion in the light spread area but other than the light reflecting surface is formed of a surface having a normal vector along which the light is reflected and directed outside a predetermined area.

According to the configuration described above, each portion in the light spread area but other than the movable plate is formed of a surface having a normal vector along which the externally incident light is reflected and directed outside a predetermined area (specific normal vector). It is generally known that the angle of incidence of light with respect to a normal vector (normal) to a reflection surface is equal to the angle of reflection of the light with respect to the normal vector. Therefore, when the direction of the normal vector to the reflection surface is changed relative to the incident light, the angle of incidence and the angle of reflection of the light can be changed. Setting the angle between the externally incident light and the normal vector to the reflection surface, that is, setting the angle of incidence of the light, at an appropriate value therefore allows the reflected light to be directed outside a predetermined area. The amount of stray light resulting from the light incident on each portion other than the movable plate can be thus reduced. The “predetermined area,” outside which the light reflected off each portion other than the movable plate is directed, includes not only an area to which the light reflected off the movable plate is directed but also other optical devices, mirrors, and screens (including screens irradiated with light via other optical device, mirrors, and other components) including the area to which the light reflected off the movable plate is directed.

The surface having the specific normal vector described above preferably includes a flat surface inclined to the movable plate by a predetermined angle.

According to the configuration described above, the surface having the specific normal vector described above includes a flat surface inclined to the movable plate by a predetermined angle. For example, a surface parallel to the movable plate can be anisotropically etched or machined with a machine tool or any other suitable tool to forma flat surface inclined to the movable plate by a predetermined angle. Setting the predetermined angle at an appropriate value therefore allows the flat surface to have the specific normal vector described above. Any portion in the light spread area but other than the movable plate can therefore readily be changed to a surface having the specific normal vector described above.

It is preferable that the optical device further includes a frame disposed to surround the movable plate and one portion in the light spread area but other than the movable plate is the frame.

According to the configuration described above, since one portion in the light spread area but other than the movable plate is the frame, which is disposed in the vicinity of the movable plate and hence a great concern that the reflected light becomes stray light, the portion of the frame within the light spread area can be formed of a surface having the specific normal vector described above. The amount of stray light resulting from the light incident on the frame can therefore be reduced.

It is preferable that the optical device further includes a support member that supports the axis member and one portion in the light spread area but other than the movable plate is the support member.

According to the configuration described above, since one portion in the light spread area but other than the movable plate is the support member, which is disposed in the vicinity of the movable plate and hence a great concern that the reflected light becomes stray light, the portion of the support member within the light spread area can be formed of a surface having the specific normal vector described above. The amount of stray light resulting from the light incident on the support member can therefore be reduced.

It is preferable that the optical device further includes a driver configured to swing the movable plate around the predetermined axis and one portion in the light spread area but other than the movable plate is the driver.

According to the configuration described above, since one portion in the light spread area but other than the movable plate is the driver, which is disposed in the vicinity of the movable plate and hence a great concern that the reflected light becomes stray light, the portion of the driver within the light spread area can be formed of a surface having the specific normal vector described above. The amount of stray light resulting from the light incident on the driver can therefore be reduced.

The predetermined area preferably includes the area to which the light reflected off the movable plate is directed.

According to the configuration described above, since the predetermined area described above includes the area to which the light reflected off the movable plate is directed, the light incident on the portions in the light spread area, over which externally incident light is spread, but other than the movable plate is reflected and directed outside the area to which the light reflected off the movable plate is directed. In other words, the area to which the light reflected off the movable plate is directed does not overlap with the area to which the light reflected off the portions other than the movable plate is directed. As a result, the concern that the light incident on the portions other than the movable plate becomes stray light in the area to which the light reflected off the movable plate is directed can be lowered.

An optical scanner according to another aspect of the invention includes the optical device according to any of the aspects of the invention described above.

According to the configuration described above, since the optical scanner includes the optical device according to any of the aspects of the invention described above, the amount of stray light resulting from the light incident on the portions other than the movable plate can be reduced. It is therefore not necessary to lower the resolution or the contrast of externally incident light in order to make the stray light less visible, unlike optical devices of related art. The resolution and the contrast of externally incident light can therefore be higher than those in optical devices of related art. An optical scanner having such excellent optical characteristics can thus be achieved.

An image forming apparatus according to still another aspect of the invention includes the optical scanner according to the aspect of the invention described above.

According to the configuration described above, since the image forming apparatus includes the optical scanner according to the aspect of the invention described above, the resolution and the contrast of externally incident light can be higher than those in optical devices of related art. As a result, the image forming apparatus has excellent drawing performance that allows a high-resolution, high-contrast image to be formed.

### BRIEF DESCRIPTION OF THE DRAWINGS

The invention will be described with reference to the accompanying drawings, wherein like numbers refer to like elements.

FIG. 1 is a plan view describing the configuration of an optical device according to an embodiment of the invention.

FIG. 2 is a cross-sectional view taken along the line I-I shown in FIG. 1.

FIG. 3 is a cross-sectional view taken along the line II-II shown in FIG. 1.

FIG. 4 is a plan view describing an example of the light reflected off the optical device according to the embodiment of the invention.

FIG. 5 is a schematic view showing an exemplary image forming apparatus including an optical scanner according to an embodiment of the invention.

### DESCRIPTION OF EXEMPLARY EMBODIMENTS

Embodiments of the invention will be described below with reference to the drawings.

### Optical Device

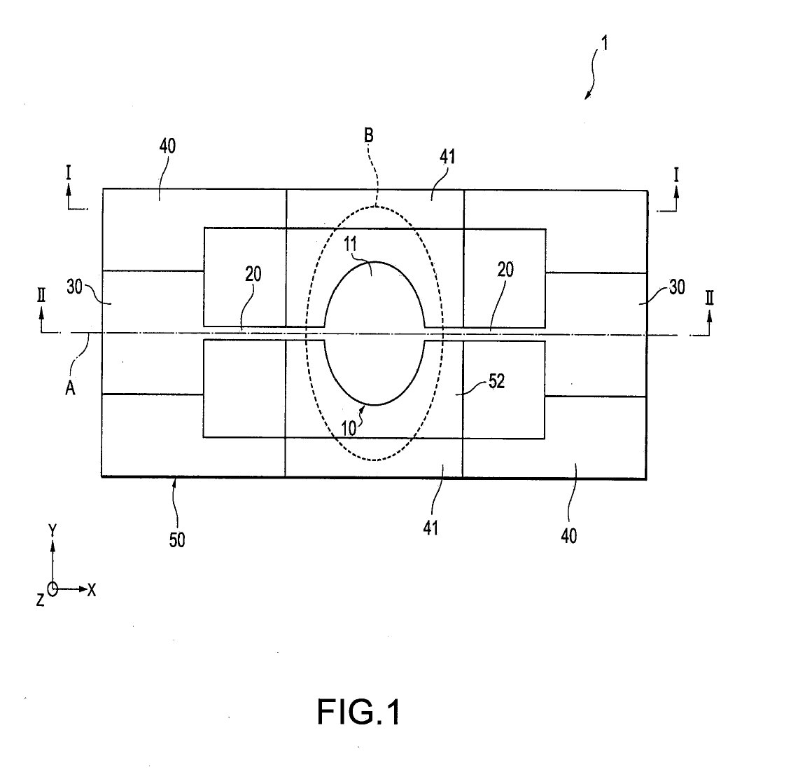

FIGS. 1 to 4 show an optical device according to an embodiment of the invention, and FIG. 1 is a plan view describing the configuration of the optical device according to the embodiment of the invention.

As shown in FIG. 1, an optical device 1 includes a movable plate 10, a pair of axis members 20, a securing portion 30, a frame 40, and a support member (holder) 50. An external light source (not shown) emits light that spreads in a normal distribution (Gauss distribution or Gaussian distribution), and the light is then incident on the optical device 1. The light is spread over the area B shown in FIG. 1.

A metal film 11 is formed on the upper surface (one surface) of the movable plate 10, and the movable plate 10 is disposed in the area B over which light is spread and reflects the light. The metal film 11 corresponds to the light reflecting surface in an embodiment of the invention. The metal film 11 can be formed on the upper surface of the movable plate 10, for example, by carrying out vacuum deposition, sputtering, metal foil bonding, or any other suitable film forming method.

The pair of axis members 20 swingably supports the movable plate 10 relative to the securing portion 30 around an axis A, which is the central axis of the axis members 20. The axis members 20 preferably have elasticity, which readily allows the axis members 20 to deform torsionally, as will be described later. The securing portion 30 is connected to the pair of axis members 20 and secures both ends of an oscillation system formed of the movable plate 10 and the axis members 20. The movable plate 10, the axis members 20, and the securing portion 30 are formed integrally with each other, for example, by etching a silicon substrate.

In the present embodiment, the movable plate 10, the axis members 20, and the securing portion 30 are formed integrally with each other. They are not necessarily formed integrally with each other but may be formed separately. Further, the shape of the movable plate 10 when viewed from the above is circular in the present embodiment. The shape is not limited to be circular but may be elliptical, rectangular, polygonal, or any other suitable shape as long as it performs the function that the movable plate 10 of the optical device 1 is required to perform.

The frame 40 has a cutout (not shown) into which the securing portion 30 fits. When the securing portion 30 fits into the cutout, the frame 40 surrounds the movable plate 10.

The cutout is preferably sized in such a way that the upper surfaces of the movable plate 10, the axis members 20, and the securing portion 30 are flush with or substantially flush with the upper surface of the frame 40.

An inclined surface 41 is formed in part of the upper surface of the frame 40, specifically, in an area including the light spread area B. The portion of the upper surface of the frame 40 other than the inclined surface 41 is a flat surface parallel to the movable plate 10. The inclined surface 41 has a normal vector along which externally incident light is reflected and directed outside a predetermined area (hereinafter referred to as a specific normal vector). It is generally known that the angle of incidence of light with respect to a normal vector (normal) to a reflection surface is equal to the angle of reflection of the light with respect to the normal vector. Therefore, when the direction of the normal vector to the reflection surface is changed relative to the incident light, the angle of incidence and the angle of reflection of the light can be changed. Setting the angle between the externally incident light and the normal vector to the reflection surface, that is, setting the angle of incidence of the light, at an appropriate value therefore allows the reflected light to be directed outside a predetermined area.

The predetermined area outside which the light reflected off the inclined surface 41 is directed preferably includes an area D to which the light reflected off the movable plate 10 is directed when the movable plate 10 swings around the axis A, as will be described later. The predetermined area preferably further includes other optical devices, mirrors, screens (including screens irradiated with light via other optical device, mirrors, and other components) including the light reflected area D.

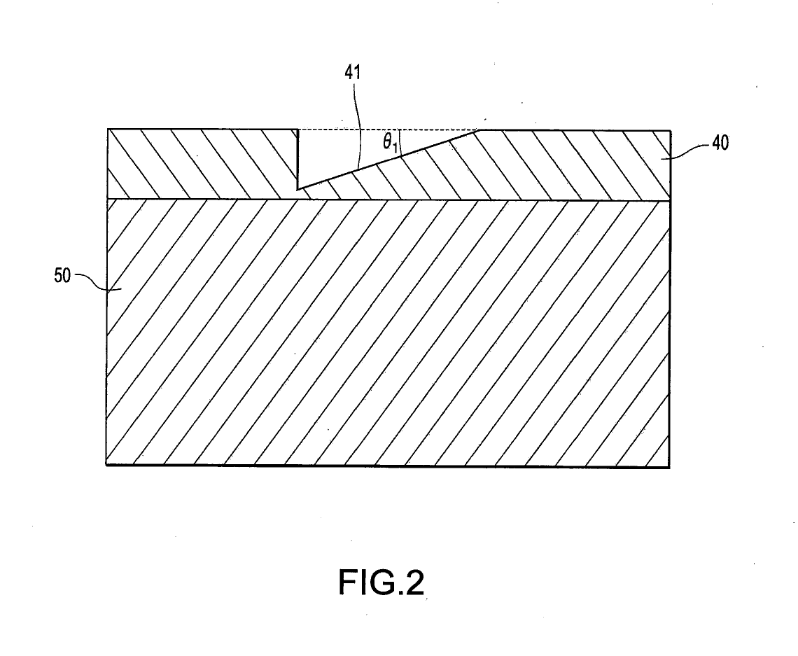

FIG. 2 is a cross-sectional view taken along the line I-I shown in FIG. 1. As shown in FIG. 2, the inclined surface 41 on one side of the frame 40 (upper side in FIG. 1) is a flat surface inclined to a surface parallel to the movable plate 10 by a predetermined angle θ₁. For example, the upper surface of the frame 40, which is parallel to the movable plate 10, can be anisotropically etched or machined with a machine tool or any other suitable tool to form the inclined surface 41 inclined to a surface parallel to the movable plate 10 by the predetermined angle θ₁. Setting the predetermined angle θ₁ at an appropriate value therefore allows the inclined surface 41 to have its specific normal vector described above.

While FIG. 2 shows only the inclined surface 41 on one side of the frame 40 (upper side in FIG. 1), the inclined surface 41 on the other side of the frame 40 (lower side in FIG. 1) is also a flat surface inclined to a surface parallel to the movable plate 10 by a predetermined angle θ₂. The direction in which the inclined surface 41 on the one side is inclined may or may not be the same as the direction in which the inclined surface 41 on the other side is inclined. Further, the predetermined angle θ₁ may or may not be equal to the predetermined angle θ₂.

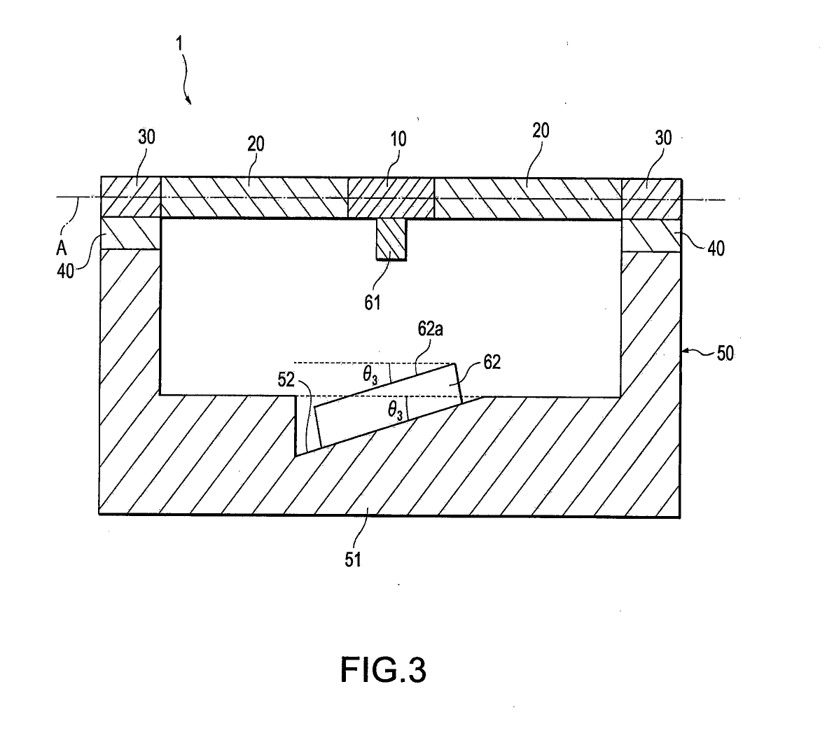

FIG. 3 is a cross-sectional view taken along the line II-II shown in FIG. 1. As shown in FIG. 3, the support member 50 supports the frame 40 from the below and is bonded to the frame 40 with an adhesive (not shown). The support member 50 thus supports the frame 40 and hence the axis members 20 via the securing portion 30, which fits in the cutout in the frame 40.

The support member 50 has a bottom portion 51 facing the movable plate 10. An inclined surface 52 is formed in part of the upper surface of the bottom portion 51, specifically, in an area including the light spread area B shown in FIG. 1. The portion of the upper surface of the bottom portion 51 other than the inclined surface 52 is a flat surface parallel to the movable plate 10. The inclined surface 52 has its specific normal vector described above.

The inclined surface 52 in the bottom portion 51 is a flat surface inclined to a surface parallel to the movable plate 10 by a predetermined angle θ₃. For example, the upper surface of the bottom portion 51, which is parallel to the movable plate 10, can be anisotropically etched or machined with a machine tool or any other suitable tool to form the inclined surface 52 inclined to the movable plate 10 by the predetermined angle θ₃. Setting the predetermined angle θ₃ at an appropriate value therefore allows the inclined surface 52 to have its specific normal vector described above.

The direction in which the inclined surface 52 is inclined may or may not be the same as the direction in which the inclined surface 41 shown in FIG. 2 is inclined. Further, the predetermined angle θ₃ may or may not be equal to the predetermined angle θ₁. Similarly, the predetermined angle θ₃ may or may not be equal to the predetermined angle θ₂.

While the present embodiment has been described with reference to the case where the support member 50 is a member separate from the frame 40, the support member 50 is not necessarily separate from the frame 40 but may be integrated therewith. Further, while the securing portion 30 fits into the cutout (not shown) in the frame 40 in the present embodiment, the securing portion 30 does not necessarily fit into a cutout, and the optical device 1 does not necessarily have the frame 40. In this case, the securing portion 30 is bonded to the support member 50 with an adhesive or any other suitable means.

A magnet 61 is bonded to the lower surface (the other surface) of the movable plate 10 with an adhesive (not shown). In a plan view of the optical device 1, the magnet 61 is magnetized in the direction perpendicular to the axis A (the

Y-axis direction in FIG. 1). That is, the magnet 61 has a pair of magnetic poles having different polarities on opposite sides of the axis A.

The magnet 61 has been described as a member separate from the movable plate 10 in the present embodiment, but the magnet 61 is not necessarily configured as described above. The magnet 61 may alternatively be formed integrally with the movable plate 10. In this case, the magnet 61 is formed on the lower surface (the other surface) of the movable plate 10 by carrying out sputtering or any other suitable film forming method.

A coil 62 for swinging the movable plate 10 around the axis A is provided on the inclined surface 52 in the bottom portion 51. In this configuration, the upper surface 62a of the coil 62 is a flat surface inclined to a surface parallel to the movable plate 10 by the predetermined angle θ₃ and has its specific normal vector described above, like the inclined surface 52 in the bottom portion 51.

A power source (not shown) supplies AC current alternating at a predetermined frequency to the coil 62. The coil 62 then produces a magnetic field oriented upward (toward the movable plate 10) and a magnetic field oriented downward in an alternating manner. The alternating magnetic field causes one of the pair of magnetic poles of the magnet 61 to approach the coil 62 and the other magnetic pole to move away therefrom. As a result, the axis members 20 torsionally deform, and the movable plate 10 and the magnet 61 swing around the axis A accordingly.

The predetermined frequency of the AC current supplied to the coil 62 is preferably set to substantially coincide with the number of oscillation (torsional resonance frequency) of the oscillation system formed of the movable plate 10 and the axis members 20. Using the resonance as described above allows the deflection angle of the movable plate 10 that swings around the axis A to be increased at low power consumption.

In the present embodiment, a drive method using the electromagnetic force between the magnet 61 and the coil 62 has been presented. The drive method does not necessarily use an electromagnetic force, and any other method may be employed as long as the movable plate 10 swings around a predetermined axis. A method using electrostatic attraction or a drive method using a piezoelectric element may be employed to drive the optical device 1. For example, when a method using electrostatic attraction is employed, the magnet 61 is not necessary, and the coil 62 is replaced with one or more electrodes disposed on the inclined surface 52 in the bottom portion 51 in such a way that the electrodes face the movable plate 10. An AC voltage alternating at a predetermined frequency is then applied between the movable plate 10 and the electrodes to produce electrostatic attraction between the movable plate 10 and the electrodes. As a result, the axis members 20 torsionally deform, and the movable plate 10 swings around the axis A.

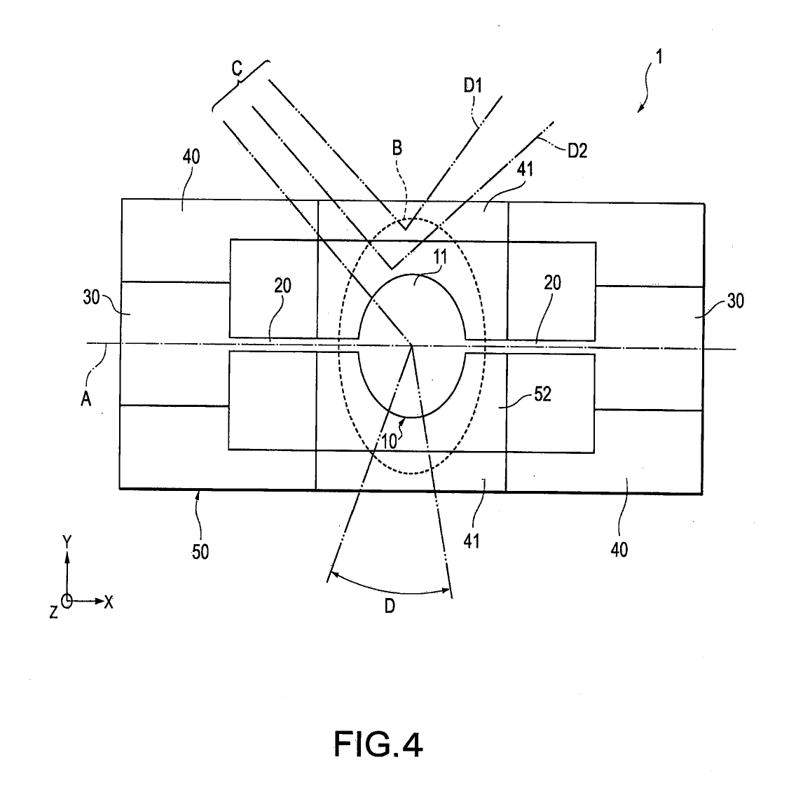

FIG. 4 is a plan view describing an example of the light reflected off the optical device 1 according to the present embodiment of the invention. As shown in FIG. 4, when light C is externally incident on the optical device 1, the light C incident on the movable plate 10, which swings around the axis A, is reflected and directed toward the reflected area D.

In contrast, the light C incident on the inclined surface 41 having its specific normal vector described above is reflected but is not directed to the area D to which the light reflected off the movable plate 10 is directed, as indicated by reflected light D1. The light C incident on the inclined surface 52 having its specific normal vector described above is reflected but is not directed to the area D to which the light reflected off the movable plate 10 is directed, as indicated by reflected light D2. Although not shown, the light incident on the upper surface 62a of the coil 62, which has its specific normal vector described above, is also reflected but is not directed to the area D to which the light reflected off the movable plate 10 is directed.

The inclined surface 41 of the frame 40, the inclined surface 52 of the bottom portion 51, and the upper surface 62a of the coil 62 are presented as the portions in the light spread area B but other than the movable plate 10 in the present embodiment, but the portions in the light spread area B but other than the movable plate 10 are not limited thereto. Other portions of the optical device 1, for example, column-shaped portions of the support member 50, may be considered as the portions in the light spread area B but other than the movable plate 10 as long as they are included in the light spread area B. Further, the flat surfaces inclined to the movable plate 10 by the respective predetermined angles are presented as a surface having its specific normal vector described above in the present embodiment, but a surface having its specific normal vector described above is not limited thereto. For example, any other surface, such as a curved surface, may be employed as long as it is a surface having its specific normal vector described above.

As described above, according to the optical device 1 in the present embodiment, any of the portions in the light spread area B but other than the movable plate 10 is formed of a surface having a normal vector along which externally incident light is reflected and directed outside a predetermined area (specific normal vector). It is generally known that the angle of incidence of light with respect to a normal vector (normal) to a reflection surface is equal to the angle of reflection of the light with respect to the normal vector. Therefore, when the direction of the normal vector to the reflection surface is changed relative to the incident light, the angle of incidence and the angle of reflection of the light can be changed. Setting the angle between the externally incident light and the normal vector to the reflection surface, that is, setting the angle of incidence of the light, at an appropriate value therefore allows the reflected light to be directed outside a predetermined area. The amount of stray light resulting from the light incident on the portions other than the movable plate 10 can be thus reduced.

Further, according to the optical device 1 in the present embodiment, a surface having its specific normal vector described above includes a flat surface inclined to the movable plate 10 by a predetermined angle. For example, a surface parallel to the movable plate 10 can be anisotropically etched or machined with a machine tool or any other suitable tool to form a flat surface inclined to the movable plate 10 by a predetermined angle. Setting the predetermined angle at an appropriate value therefore allows the flat surface to be a surface having its specific normal vector described above. Any portion in the light spread area B but other than the movable plate 10 can readily be changed to a surface having its specific normal vector described above.

Further, according to the optical device 1 in the present embodiment, since one of the portions in the light spread area B but other than the movable plate 10 is the frame 40, which is disposed in the vicinity of the movable plate 10 and hence a great concern that the reflected light becomes stray light, the inclined surface 41 of the frame 40 within the light spread area B can be formed of a surface having its specific normal vector described above. The amount of stray light resulting from the light incident on the frame 40 can therefore be reduced.

Further, according to the optical device 1 in the present embodiment, since one of the portions in the light spread area B but other than the movable plate 10 is the support member 50, which is disposed in the vicinity of the movable plate 10 and hence a great concern that the reflected light becomes stray light, the inclined surface 52 of the bottom portion 51 of the support member 50 within the light spread area B can be formed of a surface having its specific normal vector described above. The amount of stray light resulting from the light incident on the support member 50 can therefore be reduced.

Further, according to the optical device 1 in the present embodiment, since one of the portions in the light spread area B but other than the movable plate 10 is the coil 62, which is disposed in the vicinity of the movable plate 10 and hence a great concern that the reflected light becomes stray light, the upper surface 62a of the coil 62 within the light spread area B can be formed of a surface having its specific normal vector described above. The amount of stray light resulting from the light incident on the coil 62 can therefore be reduced.

Further, according to the optical device 1 in the present embodiment, since the predetermined area described above includes the area D to which the light reflected off the movable plate 10 is directed, the light incident on the portions in the area B, over which externally incident light is spread, but other than the movable plate 10 is reflected and directed outside the area D to which the light reflected off the movable plate 10 is directed. In other words, the area D to which the light reflected off the movable plate 10 is directed does not overlap with the area to which the light reflected off the portions other than the movable plate 10 is directed. As a result, the concern that the light incident on the portions other than the movable plate 10 becomes stray light in the area D to which the light reflected off the movable plate 10 is directed can be lowered.

### Optical Scanner

Since the optical device 1 described above includes the movable plate 10 with the metal film 11 as shown in FIG. 1, the optical device 1 can be suitably used as an optical scanner provided in a laser printer, a barcode reader, a confocal laser scanning microscope, an imaging display, and other image forming apparatus. The optical scanner according to an embodiment of the invention has the same configuration as that of the optical device 1 described above, and no description of the optical scanner will be made.

As described above, the optical scanner according to an embodiment of the invention can reduce the amount of stray light resulting from the light incident on the portions other than the movable plate 10. It is therefore not necessary to lower the resolution or the contrast of externally incident light in order to make the stray light less visible, unlike optical devices of related art. The resolution and the contrast of externally incident light can therefore be higher than those in optical devices of related art. An optical scanner having such excellent optical characteristics can thus be achieved.

### Image Forming Apparatus

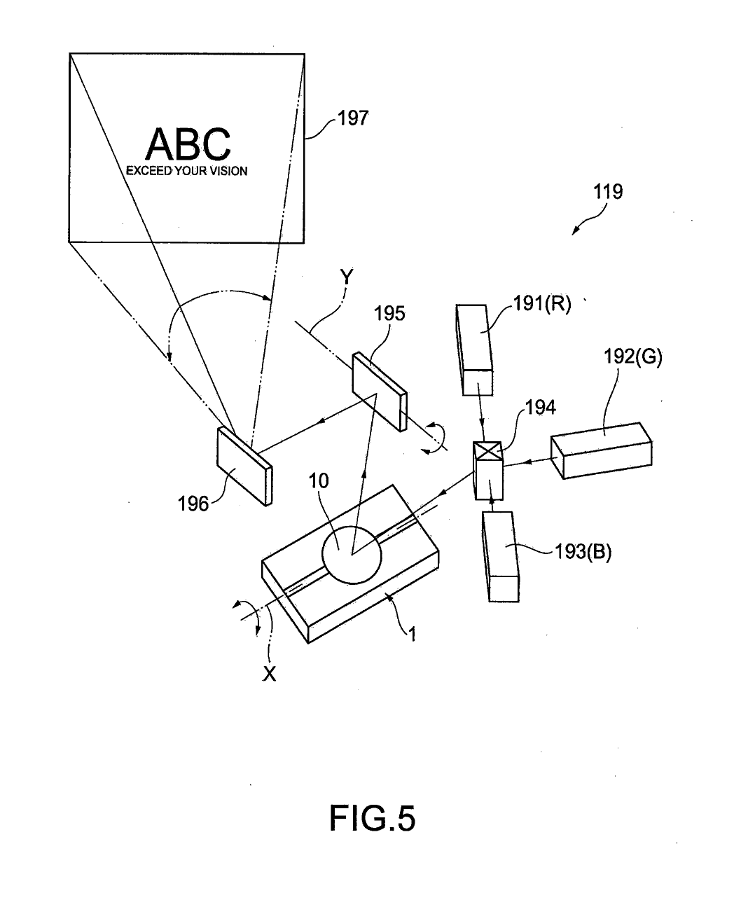

An image forming apparatus according to an embodiment of the invention will be described with reference to FIG. 5. FIG. 5 is a schematic view describing an exemplary image forming apparatus including the optical scanner according to an embodiment of the invention.

An image forming apparatus (imaging display) 119 shown in FIG. 5 includes the optical device 1, which is the optical scanner, light sources 191, 192, and 193 that emit R (red), G (green), and B (blue) three color light beams, respectively, a cross dichroic prism (X prism) 194, a galvanometric mirror 195, a fixed mirror 196, and a screen 197.

In the image forming apparatus 119, the light sources 191, 192, and 193 emit the color light beams toward (the movable plate 10 of) the optical device 1 via the cross dichroic prism 194. The red light from the light source 191, the green light from the light source 192, and the blue light from the light source 193 are combined in the cross dichroic prism 194. The light reflected off the movable plate 10 (combined three-color light) is reflected off the galvanometric mirror 195, reflected off the fixed mirror 196, and incident on the screen 197.

In this process, the action of the optical device 1 (the swing motion of the movable plate 10 around an axial line X) causes the light reflected off the movable plate 10 to be scanned in the horizontal direction of the screen 197 (primary scan). The light incident on the portions other than the movable plate 10 is reflected and directed outside a predetermined area, that is, outside the galvanometric mirror 195 and the screen 197. The concern that the light incident on the portions other than the movable plate 10 becomes stray light on the galvanometric mirror 195 and the screen 197 can thus be lowered.

On the other hand, the pivotal motion of the galvanometric mirror 195 around an axial line Y causes the light reflected off the movable plate 10 to be scanned in the vertical direction of the screen 197 (secondary scan). The intensities of the light beams outputted from the color light sources 191, 192, and 193 change in accordance with image information received from a host computer (not shown).

As described above, since the image forming apparatus 119 according to this embodiment of the invention includes the optical scanner according to the embodiment of the invention described above, the resolution and the contrast of externally incident light can be higher than those in optical devices of related art. As a result, the image forming apparatus 119 has excellent drawing performance that allows a high-resolution, high-contrast image to be formed.

It is noted that the configuration of any of the embodiments described above may be combined with any of the other configurations or part of the configuration of any of the embodiments described above may be replaced with part of any of the other configurations. Further, the configuration of the invention is not limited to those of the embodiments described above, but a variety of changes may be made thereto to the extent that they do not depart from the spirit of the invention.

What is claimed is:

1. An optical device comprising:
a movable plate disposed in an area over which externally incident light is spread, the movable plate having a light reflecting surface that reflects the light; and
an axis member that swingably supports the movable plate around a predetermined axis,
wherein each portion in the light spread area but other than the movable plate is formed of a surface having a normal vector along which the light is reflected and directed outside a predetermined area.

2. The optical device according to claim 1,
wherein the surface having the normal vector includes a flat surface inclined to the movable plate by a predetermined angle.

3. The optical device according to claim 1,
further comprising a frame disposed to surround the movable plate,
wherein one portion in the light spread area but other than the movable plate is the frame.

4. The optical device according to claim 1,
further comprising a support member that supports the axis member,
wherein one portion in the light spread area but other than the movable plate is the support member.

5. The optical device according to claim 1,
further comprising a driver configured to swing the movable plate around the predetermined axis,
wherein one portion in the light spread area but other than the movable plate is the driver.

6. The optical device according to claim 1,
wherein the predetermined area includes the area to which the light reflected off the movable plate is directed.

7. An optical scanner comprising the optical device according to claim 1.

8. An image forming apparatus comprising the optical scanner according to claim 7.
